(19) United States
(12) Patent Application Publication
(10) Pub. No.: US 2024/0233049 A1
(43) Pub. Date: Jul. 11, 2024

(54) FORM GENERATION FOR BUILDING CONSTRUCTION ADDIN

(71) Applicant: University of Florida Research Foundation, Inc., Gainesville, FL (US)

(72) Inventors: Deepak Balakrishnan, Gainesville, FL (US); Ravi Shankar Srinivasan, Gainesville, FL (US)

(21) Appl. No.: 18/408,124

(22) Filed: Jan. 9, 2024

Related U.S. Application Data
(60) Provisional application No. 63/479,249, filed on Jan. 10, 2023.

(51) Int. Cl. G06Q 50/08

(52) U.S. Cl. CPC G06Q 50/08

(57) ABSTRACT

The present disclosure presents systems and methods for generating digital or electronic building construction forms using Building Information Modeling (BIM) data. One such method comprises providing an add-in application on a computing device; retrieving, by the add-in application of the computing device, a building construction form template; extracting, by the add-in application of the computing device, building design data from a Building Information Model (BIM) file of a building construction project, wherein the BIM file is generated from an external application to the add-in application; calculating, by the add-in application of the computing device, one or more of the building design metrics using the extracted building design data; and/or inputting, by the add-in application of the computing device, the extracted building design data and the calculated metrics in the specified fields of the building construction form template and generating a populated version of the building construction form.

### CROSS-REFERENCE TO RELATED APPLICATION

This application claims priority to co-pending U.S. provisional application entitled, “Form Generation for Building Construction Addin for Automated Form R405-2020 Report Generation for Compliance with Florida Energy Efficiency Code for Building Construction,” having application No. 61/414,382, filed Jan. 10, 2023, which is entirely incorporated herein by reference.

### BACKGROUND

Building construction codes institute various requirements to be met by new building constructions and existing constructions, such as an energy code for a particular state government or body. Thus, energy data metrics for a new building design are often required for building permit approval in order to assess whether the design meets the building construction code. This is typically done by submitting one or more building construction forms with calculated values of many variables or parameters proposed within the design of the building project, including but not limited to the type of construction, the insulation values, the size and type of windows, their location and orientation, etc. These calculated values are then compared to a model reference home in order to determine whether the building design is within the limits of energy consumption standards set by the code. Accordingly, the skill and know-how required to obtain the appropriate design parameters and make the proper calculations can involve much effort and costs in order to complete the necessary building construction forms and comply with the applicable government codes and laws.

### BRIEF DESCRIPTION OF THE DRAWINGS

Many aspects of the present disclosure can be better understood with reference to the following drawings. The components in the drawings are not necessarily to scale, emphasis instead being placed upon clearly illustrating the principles of the present disclosure. Moreover, in the drawings, like reference numerals designate corresponding parts throughout the several views.

FIG. 1 illustrates an example infrastructure in which one or more of the disclosed processes of the present disclosure may be implemented.

FIG. 2 is a block diagram illustrating an example computing system that may be used in connection with various embodiments of the present disclosure.

FIG. 3 is a chart of available options for complying with the Florida Energy Efficiency Code for Building Construction and their requisite forms.

FIG. 4 shows an example of a building construction form for the state of Florida.

FIG. 5 shows an exemplary process flow in accordance with embodiments of the present disclosure.

### DETAILED DESCRIPTION

In the present disclosure, systems, methods, and non-transitory computer-readable media are disclosed for generating digital or electronic building construction forms using Building Information Modeling (BIM) data, such as a forms documenting whether a building project meets the requirements of an energy code for a particular state government or body. As a non-limiting example, in the State of Florida, the Florida Building Commission issues a Florida Energy Efficiency Code for Building Construction that places requirements to be met by new building constructions. Thus, energy data metrics for a new building design are often required for building permit approval in order to assess whether the design meets the building construction code.

It is noted that building projects are often developed using building information modeling (BIM) design software, such as, but not limited to, AutoDesk Revit® software, in order to create a 3D design model of the building project. To do so, the 3D design model includes many of the variables or parameter values required to be input or used to calculate metric values for building construction forms. For example, BIM data includes spatial relationships of the project design, quantities & properties of components, and enables a wide range of project details that specify pertinent details often needed by building construction forms of a building code of a particular state.

Thus, in accordance with embodiments of the present disclosure, a building construction form tool is presented that extracts the relevant variable/parameter values from a BIM file of a building design (“BIM design file”), performs any relevant calculations, and populates appropriate fields of a building construction form with the necessary data. In various embodiments, the building construction form tool collects data from the user via a data collection interface and from the BIM design file via an application programming interface (API) interface. The data collection interface provides data entry fields for the user to enter a particular type of information (e.g. a data set) and the API interface extracts data from the BIM design file, both of which are to be entered in a building construction form template for generating of the completed (or partially completed) building construction form. The form may be created using a programming language capable of generating a document that reserves a place for data to be input, such as a spreadsheet, a word processing document, a document created using PDF, etc.

In some embodiments, the building construction form tool comprises a plug-in piece of software for an existing computer program, such as building information modeling design software (e.g., Autodesk Revit® software). In some embodiments, the plug-in software is installed as an external program (sometimes referred to as “add-in”) and allows the user of the software program to extract variable or parameter values from a BIM file for a building project, retrieve the building construction form template, determine field values required by the building construction form template using the extracted variable values, generate a completed or partially completed building construction form by inputting the field values into the building construction form template, and/or transmit a completed form to the applicable government authority. In some embodiments, the plug-in software shows the data collection interface embedded with buttons or dropdown menus for enabling actions for selecting a particular building construction form template, BIM design file, and/or other actions related to generating the building construction form as disclosed herein. In some embodiments, the plug-in software can run in the cloud-computing environment or in a desktop application.

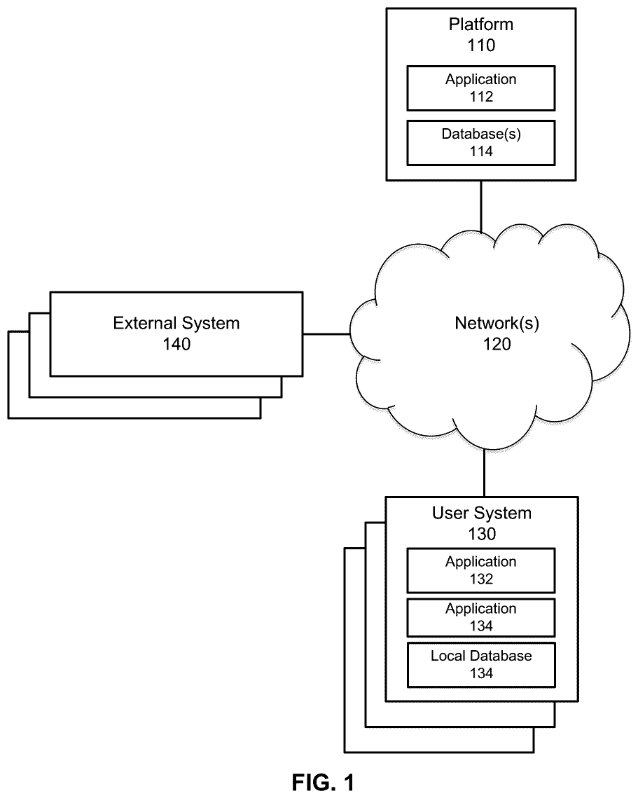

FIG. 1 illustrates an example infrastructure in which one or more of the disclosed processes may be implemented, according to an embodiment. The infrastructure may comprise a platform 110 (e.g., one or more servers) which hosts and/or executes one or more of the various functions, processes, methods, and/or software modules described herein. Platform 110 may comprise dedicated servers, or may instead comprise cloud instances, which utilize shared resources of one or more servers. These servers or cloud instances may be collocated and/or geographically distributed. Platform 110 may also comprise or be communicatively connected to a server application 112 and/or one or more databases 114. In addition, platform 110 may be communicatively connected to one or more user systems 130 via one or more networks 120. Platform 110 may also be communicatively connected to one or more external systems 140 (e.g., other platforms, websites, etc.) via one or more networks 120.

In various embodiments, the user system 130 may execute a client copy of the BIM platform software (“application 132” in FIG. 1) that may use resources stored in the platform 110 (such as by making requests to a BIM design software server component (“application 112” in FIG. 1) or other remote resources, such as building construction form templates (stored in database 114) with instructions for locating variables/parameters within a BIM design model). Correspondingly, the building construction form tool add-in (“application 134” in FIG. 1) may also be executed by the user system 130 and the building construction form tool 134 may be utilize services of or being in communication with external systems 140, such as a state database server that maintains or accepts building construction forms.

Network(s) 120 may comprise the Internet, and platform 110 may communicate with user system(s) 130 through the Internet using standard transmission protocols, such as HyperText Transfer Protocol (HTTP), HTTP Secure (HTTPS), File Transfer Protocol (FTP), FTP Secure (FTPS), Secure Shell FTP (SFTP), and the like, as well as proprietary protocols. While platform 110 is illustrated as being connected to various systems through a single set of network(s) 120, it should be understood that platform 110 may be connected to the various systems via different sets of one or more networks. For example, platform 110 may be connected to a subset of user systems 130 and/or external systems 140 via the Internet, but may be connected to one or more other user systems 130 and/or external systems 140 via an intranet. Furthermore, while only a few user systems 130 and external systems 140, one server application 112, and one set of database(s) 114 are illustrated, it should be understood that the infrastructure may comprise any number of user systems, external systems, server applications, and databases.

User system(s) 130 may comprise any type or types of computing devices capable of wired and/or wireless communication, including without limitation, desktop computers, laptop computers, tablet computers, smart phones or other mobile phones, servers, and/or the like.

Platform 110 may comprise web servers which host one or more websites and/or web services. In embodiments in which a website is provided, the website may comprise a graphical user interface, including, for example, one or more screens (e.g., webpages) generated in HyperText Markup Language (HTML) or other language. Platform 110 transmits or serves one or more screens of the graphical user interface in response to requests from user system(s) 130. In some embodiments, these screens may be served in the form of a wizard, in which case two or more screens may be served in a sequential manner, and one or more of the sequential screens may depend on an interaction of the user or user system 130 with one or more preceding screens. The requests to platform 110 and the responses from platform 110, including the screens of the graphical user interface, may both be communicated through network(s) 120, which may include the Internet, using standard communication protocols (e.g., HTTP, HTTPS, etc.). These screens (e.g., webpages) may comprise a combination of content and elements, such as text, images, videos, animations, references (e.g., hyperlinks), frames, inputs (e.g., textboxes, text areas, checkboxes, radio buttons, drop-down menus, buttons, forms, etc.), scripts (e.g., JavaScript), and the like, including elements comprising or derived from data stored in one or more databases (e.g., database(s) 114) that are locally and/or remotely accessible to platform 110. Platform 110 may also respond to other requests from user system(s) 130.

Platform 110 may further comprise, be communicatively coupled with, or otherwise have access to one or more database(s) 114. For example, platform 110 may comprise one or more database servers which manage one or more databases 114. A user system 130 or server application 112 executing on platform 110 may submit data (e.g., user data, form data, etc.) to be stored in database(s) 114, and/or request access to data stored in database(s) 114. Any suitable database may be utilized, including without limitation MySQL™, Oracle™, IBM™, Microsoft SQL™, Access™, PostgreSQL™, and the like, including cloud-based databases and proprietary databases. Data may be sent to platform 110, for instance, using the well-known POST request supported by HTTP, via FTP, and/or the like. This data, as well as other requests, may be handled, for example, by server-side web technology, such as a servlet or other software module (e.g., comprised in server application 112), executed by platform 110.

In embodiments in which a web service is provided, platform 110 may receive requests from external system(s) 140, and provide responses in extensible Markup Language (XML), JavaScript Object Notation (JSON), and/or any other suitable or desired format. In such embodiments, platform 110 may provide an application programming interface (API) which defines the manner in which user system(s) 130 and/or external system(s) 140 may interact with the web service. Thus, user system(s) 130 and/or external system(s) 140 (which may themselves be servers), can define their own user interfaces, and rely on the web service to implement or otherwise provide the backend processes, methods, functionality, storage, and/or the like, described herein. For example, in such an embodiment, a client application 132, 134, executing on one or more user system(s) 130 and potentially using a local database 134, may interact with a server application 112 executing on platform 110 to execute one or more or a portion of one or more of the various functions, processes, methods, and/or software modules described herein. In an embodiment, client application 132, 134 may utilize a local database 134 for storing data locally on user system 130. Client application 132 may be “thin,” in which case processing is primarily carried out server-side by server application 112 on platform 110. A basic example of a thin client application 132 is a browser application, which simply requests, receives, and renders webpages at user system(s) 130, while server application 112 on platform 110 is responsible for generating the webpages and managing database functions. Alternatively, the client application may be “thick,” in which case processing is primarily carried out client-side by user system(s) 130. It should be understood that client application 132 may perform an amount of processing, relative to server application 112 on platform 110, at any point along this spectrum between “thin” and “thick,” depending on the design goals of the particular implementation. In any case, the application described herein, which may wholly reside on either platform 110 (e.g., in which case server application 112 performs all processing) or user system(s) 130 (e.g., in which case client application 132 performs all processing) or be distributed between platform 110 and user system(s) 130 (e.g., in which case server application 112 and client application 132 both perform processing), can comprise one or more executable software modules comprising instructions that implement one or more of the processes, methods, or functions of the application described herein.

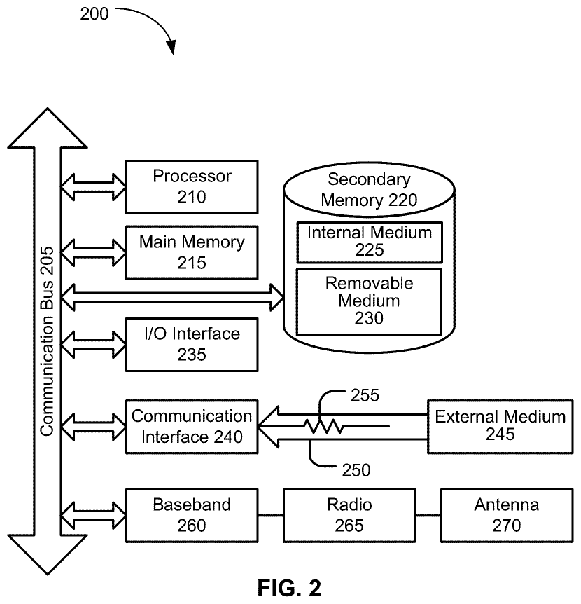

FIG. 2 is a block diagram illustrating an example computing system 200 that may be used in connection with various embodiments described herein. For example, system 200 may be used as or in conjunction with one or more of the functions, processes, or methods (e.g., to store and/or execute the application or one or more software modules of the application) described herein, and may represent components of platform 110, user system(s) 130, external system(s) 140, and/or other processing devices described herein. System 200 can be a server or any conventional personal computer, or any other processor-enabled device that is capable of wired or wireless data communication. Other computer systems and/or architectures may be also used, as will be clear to those skilled in the art.

System 200 includes one or more processors 210. Processor(s) 210 may comprise a central processing unit (CPU). Additional processors may be provided, such as a graphics processing unit (GPU), an auxiliary processor to manage input/output, an auxiliary processor to perform floating-point mathematical operations, a special-purpose microprocessor having an architecture suitable for fast execution of signal-processing algorithms (e.g., digital-signal processor), a slave processor subordinate to the main processing system (e.g., back-end processor), an additional microprocessor or controller for dual or multiple processor systems, and/or a coprocessor. Such auxiliary processors may be discrete processors or may be integrated with processor 210. Examples of processors which may be used with system 200 include, without limitation, the Pentium® processor, Core i7® processor, and Xeon® processor, all of which are available from Intel Corporation of Santa Clara, California.

Processor 210 is connected to a communication bus 205. Communication bus 205 may include a data channel for facilitating information transfer between storage and other peripheral components of system 200. Furthermore, communication bus 205 may provide a set of signals used for communication with processor 210, including a data bus, address bus, and/or control bus (not shown). Communication bus 205 may comprise any standard or non-standard bus architecture such as, for example, bus architectures compliant with industry standard architecture (ISA), extended industry standard architecture (EISA), Micro Channel Architecture (MCA), peripheral component interconnect (PCI) local bus, standards promulgated by the Institute of Electrical and Electronics Engineers (IEEE) including IEEE 488 general-purpose interface bus (GPIB), IEEE 696/S-100, and/or the like.

System 200 includes a main memory 215 and may also include a secondary memory 220. Main memory 215 provides storage of instructions and data for programs executing on processor 210, such as one or more of the functions and/or modules discussed herein. It should be understood that programs stored in the memory and executed by processor 210 may be written and/or compiled according to any suitable language, including without limitation C, C#, C++, Python, Java, JavaScript, Perl, Visual Basic, .NET, and the like. Main memory 215 is typically semiconductor-based memory such as dynamic random access memory (DRAM) and/or static random access memory (SRAM). Other semiconductor-based memory types include, for example, synchronous dynamic random access memory (SDRAM), Rambus dynamic random access memory (RDRAM), ferroelectric random access memory (FRAM), and the like, including read only memory (ROM).

Secondary memory 220 may optionally include an internal medium 225 and/or a removable medium 230. Removable medium 230 is read from and/or written to in any well-known manner. Removable storage medium 230 may be, for example, a magnetic tape drive, a compact disc (CD) drive, a digital versatile disc (DVD) drive, other optical drive, a flash memory drive, and/or the like.

Secondary memory 220 is a non-transitory computer-readable medium having computer-executable code (e.g., disclosed software modules) and/or other data stored thereon. The computer software or data stored on secondary memory 220 is read into main memory 215 for execution by processor 210.

In alternative embodiments, secondary memory 220 may include other similar means for allowing computer programs or other data or instructions to be loaded into system 200. Such means may include, for example, a communication interface 240, which allows software and data to be transferred from external storage medium 245 to system 200. Examples of external storage medium 245 may include an external hard disk drive, an external optical drive, an external magneto-optical drive, and/or the like. Other examples of secondary memory 220 may include semiconductor-based memory, such as programmable read-only memory (PROM), erasable programmable read-only memory (EPROM), electrically erasable read-only memory (EEPROM), and flash memory (block-oriented memory similar to EEPROM).

As mentioned above, system 200 may include a communication interface 240. Communication interface 240 allows software and data to be transferred between system 200 and external devices (e.g. printers), networks, or other information sources. For example, computer software or executable code may be transferred to system 200 from a network server (e.g., platform 110) via communication interface 240. Examples of communication interface 240 include a built-in network adapter, network interface card (NIC), Personal Computer Memory Card International Association (PCMCIA) network card, card bus network adapter, wireless network adapter, Universal Serial Bus (USB) network adapter, modem, a wireless data card, a communications port, an infrared interface, an IEEE 1394 fire-wire, and any other device capable of interfacing system 200 with a network (e.g., network(s) 120) or another computing device. Communication interface 240 implements industry-promulgated protocol standards, such as Ethernet IEEE 802 standards, Fiber Channel, digital subscriber line (DSL), asynchronous digital subscriber line (ADSL), frame relay, asynchronous transfer mode (ATM), integrated digital services network (ISDN), personal communications services (PCS), transmission control protocol/Internet protocol (TCP/IP), serial line Internet protocol/point to point protocol (SLIP/PPP), and so on, but may also implement customized or non-standard interface protocols as well.

Software and data transferred via communication interface 240 are generally in the form of electrical communication signals 255. These signals 255 may be provided to communication interface 240 via a communication channel 250. In an embodiment, communication channel 250 may be a wired or wireless network (e.g., network(s) 120), or any variety of other communication links. Communication channel 250 carries signals 255 and can be implemented using a variety of wired or wireless communication means including wire or cable, fiber optics, conventional phone line, cellular phone link, wireless data communication link, radio frequency (“RF”) link, or infrared link, just to name a few.

Computer-executable code (e.g., computer programs, such as the disclosed application, or software modules) is stored in main memory 215 and/or secondary memory 220. Computer programs can also be received via communication interface 240 and stored in main memory 215 and/or secondary memory 220. Such computer programs, when executed, enable system 200 to perform the various functions of the disclosed embodiments as described elsewhere herein.

In this description, the term “computer-readable medium” is used to refer to any non-transitory computer-readable storage media used to provide computer-executable code and/or other data to or within system 200. Examples of such media include main memory 215, secondary memory 220 (including internal memory 225, removable medium 230, and external storage medium 245), and any peripheral device communicatively coupled with communication interface 240 (including a network information server or other network device). These non-transitory computer-readable media are means for providing executable code, programming instructions, software, and/or other data to system 200.

In an embodiment that is implemented using software, the software may be stored on a computer-readable medium and loaded into system 200 by way of removable medium 230, I/O interface 235, or communication interface 240. In such an embodiment, the software is loaded into system 200 in the form of electrical communication signals 255. The software, when executed by processor 210, causes processor 210 to perform one or more of the processes and functions described elsewhere herein.

In an embodiment, I/O interface 235 provides an interface between one or more components of system 200 and one or more input and/or output devices. Example input devices include, without limitation, sensors, keyboards, touch screens or other touch-sensitive devices, cameras, biometric sensing devices, computer mice, trackballs, pen-based pointing devices, and/or the like. Examples of output devices include, without limitation, other processing devices, cathode ray tubes (CRTs), plasma displays, light-emitting diode (LED) displays, liquid crystal displays (LCDs), printers, vacuum fluorescent displays (VFDs), surface-conduction electron-emitter displays (SEDs), field emission displays (FEDs), and/or the like. In some cases, an input and output device may be combined, such as in the case of a touch panel display (e.g., in a smartphone, tablet, or other mobile device).

System 200 may also include optional wireless communication components that facilitate wireless communication over a voice network and/or a data network (e.g., in the case of user system 130). The wireless communication components comprise an antenna system 270, a radio system 265, and a baseband system 260. In system 200, radio frequency (RF) signals are transmitted and received over the air by antenna system 270 under the management of radio system 265.

In an embodiment, antenna system 270 may comprise one or more antennae and one or more multiplexors (not shown) that perform a switching function to provide antenna system 270 with transmit and receive signal paths. In the receive path, received RF signals can be coupled from a multiplexor to a low noise amplifier (not shown) that amplifies the received RF signal and sends the amplified signal to radio system 265.

In an alternative embodiment, radio system 265 may comprise one or more radios that are configured to communicate over various frequencies. In an embodiment, radio system 265 may combine a demodulator (not shown) and modulator (not shown) in one integrated circuit (IC). The demodulator and modulator can also be separate components. In the incoming path, the demodulator strips away the RF carrier signal leaving a baseband receive audio signal, which is sent from radio system 265 to baseband system 260.

If the received signal contains audio information, then baseband system 260 decodes the signal and converts it to an analog signal. Then the signal is amplified and sent to a speaker. Baseband system 260 also receives analog audio signals from a microphone. These analog audio signals are converted to digital signals and encoded by baseband system 260. Baseband system 260 also encodes the digital signals for transmission and generates a baseband transmit audio signal that is routed to the modulator portion of radio system 265. The modulator mixes the baseband transmit audio signal with an RF carrier signal, generating an RF transmit signal that is routed to antenna system 270 and may pass through a power amplifier (not shown). The power amplifier amplifies the RF transmit signal and routes it to antenna system 270, where the signal is switched to the antenna port for transmission.

Baseband system 260 is also communicatively coupled with processor(s) 210. Processor(s) 210 may have access to data storage areas 215 and 220. Processor(s) 210 are configured to execute instructions (i.e., computer programs, such as the disclosed application, or software modules) that can be stored in main memory 215 or secondary memory 220. Computer programs can also be received from baseband processor 260 and stored in main memory 210 or in secondary memory 220, or executed upon receipt. Such computer programs, when executed, enable system 200 to perform the various functions of the disclosed embodiments.

Embodiments of processes for generating building construction forms using Building Information Modeling (BIM) data will now be described in detail. It should be understood that the described processes may be embodied in one or more software modules that are executed by one or more hardware processors (e.g., processor 210), for example, as the application discussed herein (e.g., client application 134 and/or a distributed application comprising client application 132, client application 134, and/or server application 112), which may be executed wholly by processor(s) of user system(s) 130 or may be distributed across platform 110 and user system(s) 130, such that some portions or modules of the application are executed by platform 110 and other portions or modules of the application are executed by user system(s) 130. The described processes may be implemented as instructions represented in source code, object code, and/or machine code. These instructions may be executed directly by hardware processor(s) 210, or alternatively, may be executed by a virtual machine operating between the object code and hardware processors 210. In addition, the disclosed application may be built upon or interfaced with one or more existing systems.

Alternatively, the described processes may be implemented as a hardware component (e.g., general-purpose processor, integrated circuit (IC), application-specific integrated circuit (ASIC), digital signal processor (DSP), field-programmable gate array (FPGA) or other programmable logic device, discrete gate or transistor logic, etc.), combination of hardware components, or combination of hardware and software components. To clearly illustrate the interchangeability of hardware and software, various illustrative components, blocks, modules, circuits, and steps are described herein generally in terms of their functionality. Whether such functionality is implemented as hardware or software depends upon the particular application and design constraints imposed on the overall system. Skilled persons can implement the described functionality in varying ways for each particular application, but such implementation decisions should not be interpreted as causing a departure from the scope of the claims included herein. In addition, the grouping of functions within a component, block, module, circuit, or step is for ease of description. Specific functions or steps can be moved from one component, block, module, circuit, or step to another.

Furthermore, while the processes, described herein, are illustrated with a certain arrangement and ordering of subprocesses, each process may be implemented with fewer, more, or different subprocesses and a different arrangement and/or ordering of subprocesses. In addition, it should be understood that any subprocess, which does not depend on the completion of another subprocess, may be executed before, after, or in parallel with that other independent subprocess, even if the subprocesses are described or illustrated in a particular order.

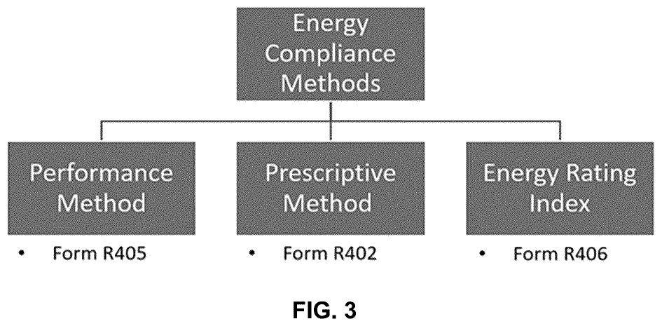

As discussed, building energy codes are regulatory guidelines that specify minimum energy efficiency standards for the residential and commercial building sectors. Building energy codes commonly mandate certain energy efficiency characteristics and set minimum efficiency requirements for buildings. As a non-limiting example and illustrated in FIG. 3, the state of Florida provides three different options for complying with the Florida Energy Efficiency Code for Building Construction (FEECBC). First, there is a prescriptive method option, where certain building component parameters will need to meet or exceed values found in sections R401-R404 of the International Energy Conservation Code (IECC). For the prescriptive method option, building construction form R402 needs to be completed and submitted to the appropriate government authority.

Another option is using the Energy Rating Index (ERI) which compares the energy performance of the building design to a baseline and requires the design to be a specified percentage better than the baseline. The baseline for the ERI is the 2006 IECC. For the Energy Rating Index option, building construction form R406 needs to be completed and submitted to the appropriate government authority in Florida.

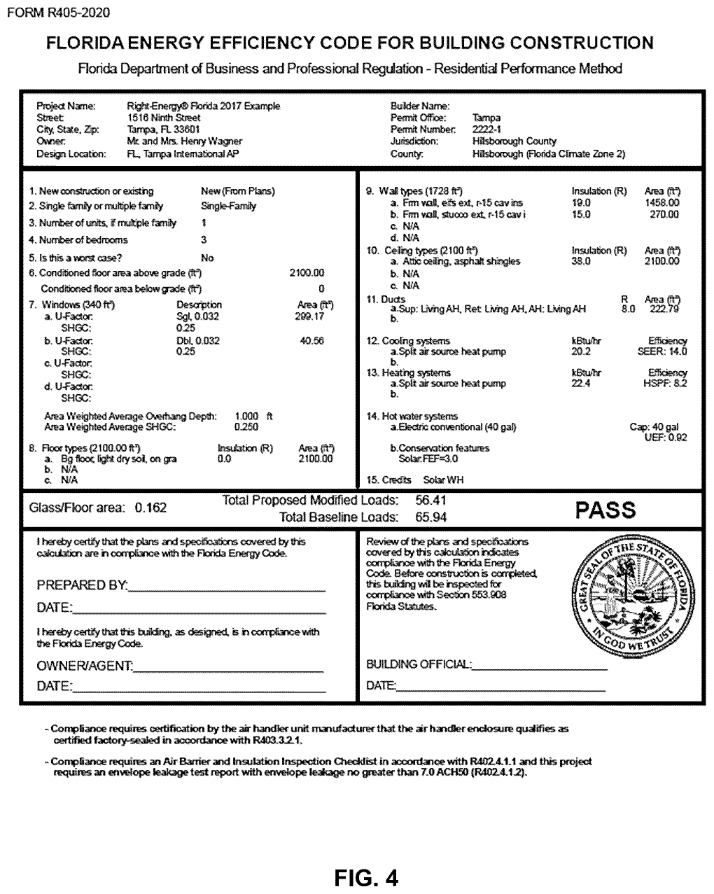

Lastly, a third option is a performance method which compares the proposed design to a baseline design that minimally meets the Illinois Energy Code (2018 IECC with Illinois amendments) to show that the proposed design will be no more costly to operate than the baseline. For the simulated performance method option, building construction form R405 needs to be completed and submitted to the appropriate government authority. FIG. 4 shows an example version of Form R405 (available at https://www.floridabuilding.org/fbc/commission/FBC_1221/Energy_TAC/Example_computer_run_reports.pdf). Completion of form R405 requires a calculation of a proposed load for the building envelope and major-energy-consuming systems and a calculation of a baseline load using ASHRAE 90.1—Appendix G (American Society of Heating, Refrigerating and Air-Conditioning Engineers Standard 90.1—Appendix G), where the proposed load should be less than or equal to the baseline load. Accordingly, the skill and know-how required to obtain the appropriate design parameters and make the proper calculations can involve much effort and costs.

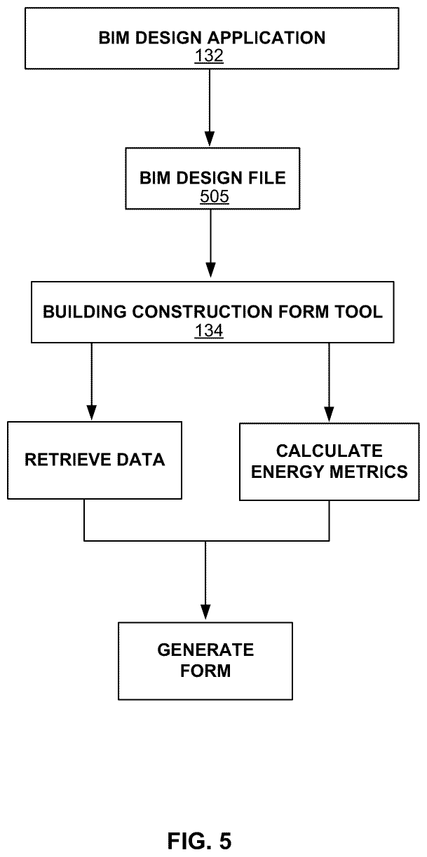

Referring now to FIG. 5, an exemplary process flow is presented to automatically generated such building construction forms in accordance with embodiments of the present disclosure. Consider that a BIM design file 505 can be generated by a BIM design software or application 132 (e.g., Autodesk Revit®) for a proposed building construction project. An exemplary building construction form tool 134 of the present disclosure is configured to access the BIM design file 505 of the proposed building design and extract building design data (e.g., dimensions, geometry, orientation, attributes, etc.) and make the necessary calculation of energy metrics (or any other building construction metric required by a particular building construction form) using parameters or variable values obtained from the BIM design file 505. The extracted and calculated data is then used to populate and generate a particular building construction form, such as Form R405 that is used in the state of Florida, in this non-limiting and illustrative example. Likewise, a similar process could be used to generate populated Forms R402 or R406 or any other type of general building construction form using BIM parameter values.

In various embodiments, the building construction form tool 134 is configured to access the BIM design application's data repository and user interface using an API (Application Programming Interface) for the BIM design application 132. In this way, an automated pipeline is enabled for passing data from the BIM design model file 505 to the electronic building construction form template and the resulting form. Such data and/or calculations may be related to conductive, convective, and radiative heat gain and loss through walls, roof/ceilings, doors, floors, windows, and skylights; solar radiant heat gain from windows and skylights; heat storage effects of different types of thermal mass; building operating schedules for people, lighting, equipment, and ventilation; space conditioning system operation including equipment part load performance; covered process mechanical equipment (kitchens, laboratories, parking garages, etc.); duct sizing for HVAC systems; R-Value parameters for walls; U-Factor computations, etc.

It should be emphasized that the above-described embodiments are merely possible examples of implementations, merely set forth for a clear understanding of the principles of the present disclosure. Many variations and modifications may be made to the above-described embodiment(s) without departing substantially from the principles of the present disclosure. All such modifications and variations are intended to be included herein within the scope of this disclosure.

Therefore, at least the following is claimed:

1. A method comprising:
providing an add-in application on a computing device;
retrieving, by the add-in application of the computing device, a building construction form template, wherein the building construction form template specifies fields for holding building design data and one or more building design metrics, wherein the building construction form template corresponds to a building construction form required by a government authority to obtain a building construction permit;
extracting, by the add-in application of the computing device, building design data from a Building Information Model (BIM) file of a building construction project, wherein the BIM file is generated from an external application to the add-in application;
calculating, by the add-in application of the computing device, one or more of the building design metrics using the extracted building design data; and
inputting, by the add-in application of the computing device, the extracted building design data and the calculated metrics in the specified fields of the building construction form template and generating a populated version of the building construction form.

2. The method of claim 1, wherein the building construction form comprises an energy code compliance form for the building construction project.

3. The method of claim 2, wherein the one or more building design metrics of the energy code compliance form requires a calculation of a baseline energy consumption load for a model home and a proposed energy consumption load for the building construction project.

4. The method of claim 2, wherein the energy code compliance form requires input of specific building component parameters, wherein the building design data comprises the specific building component parameters.

5. The method of claim 2, wherein the one or more building design metrics of the energy code compliance form requires determination of energy performance of the building construction project in comparison to a baseline and requires the building construction project to be a specified percentage better than the baseline.

6. The method of claim 2, wherein the building design data and building design metrics comprise conductive, convective, and radiative heat gain and loss through walls, roof/ceilings, doors, floors, windows, and skylights; solar radiant heat gain from windows and skylights; heat storage effects of different types of thermal mass; building operating schedules for people, lighting, equipment, and ventilation; space conditioning system operation including equipment part load performance; covered process mechanical equipment (kitchens, laboratories, parking garages, etc.); duct sizing for HVAC systems; R-Value parameters for walls; and/or U-Factor computations.

7. The method of claim 1, wherein the add-in application comprises an Application Programming Interface to the external application.

8. The method of claim 1, wherein the external application comprises a building information modeling design software.

9. A system comprising:
at least one processor; and
memory configured to communicate with the at least one processor, wherein the memory stores instructions that, in response to execution by the at least one processor, cause the at least one processor to perform operations comprising:
executing an add-in application on a computing device;
retrieving, by the add-in application of the computing device, a building construction form template, wherein the building construction form template specifies fields for holding building design data and one or more building design metrics, wherein the building construction form template corresponds to a building construction form required by a government authority to obtain a building construction permit;
extracting, by the add-in application of the computing device, building design data from a Building Information Model (BIM) file of a building construction project, wherein the BIM file is generated from an external application to the add-in application;
calculating, by the add-in application of the computing device, one or more of the building design metrics using the extracted building design data; and
inputting, by the add-in application of the computing device, the extracted building design data and the calculated metrics in the specified fields of the building construction form template and generating a populated version of the building construction form.

10. The system of claim 9, wherein the building construction form comprises an energy code compliance form for the building construction project.

11. The system of claim 10, wherein the one or more building design metrics of the energy code compliance form requires a calculation of a baseline energy consumption load for a model home and a proposed energy consumption load for the building construction project.

12. The system of claim 10, wherein the energy code compliance form requires input of specific building component parameters, wherein the building design data comprises the specific building component parameters.

13. The system of claim 10, wherein the one or more building design metrics of the energy code compliance form requires determination of energy performance of the building construction project in comparison to a baseline and requires the building construction project to be a specified percentage better than the baseline.

14. The system of claim 10, wherein the building design data and building design metrics comprise conductive, convective, and radiative heat gain and loss through walls, roof/ceilings, doors, floors, windows, and skylights; solar radiant heat gain from windows and skylights; heat storage effects of different types of thermal mass; building operating schedules for people, lighting, equipment, and ventilation; space conditioning system operation including equipment part load performance; covered process mechanical equipment (kitchens, laboratories, parking garages, etc.); duct sizing for HVAC systems; R-Value parameters for walls; and/or U-Factor computations.

15. The system of claim 9, wherein the add-in application comprises an Application Programming Interface to the external application.

16. The system of claim 9, wherein the external application comprises a building information modeling design software.

17. A non-transitory computer-readable medium having instructions stored therein, wherein the instructions, when executed by a processor, cause the processor to:
execute an add-in application on a computing device;
retrieve, by the add-in application of the computing device, a building construction form template, wherein the building construction form template specifies fields for holding building design data and one or more building design metrics, wherein the building construction form template corresponds to a building construction form required by a government authority to obtain a building construction permit;
extract, by the add-in application of the computing device, building design data from a Building Information Model (BIM) file of a building construction project, wherein the BIM file is generated from an external application to the add-in application;
calculate, by the add-in application of the computing device, one or more of the building design metrics using the extracted building design data; and
input, by the add-in application of the computing device, the extracted building design data and the calculated metrics in the specified fields of the building construction form template and generating a populated version of the building construction form.

18. The non-transitory computer-readable medium of claim 17, wherein the building construction form comprises an energy code compliance form for the building construction project.

19. The non-transitory computer-readable medium of claim 18, wherein the one or more building design metrics of the energy code compliance form requires a calculation of a baseline energy consumption load for a model home and a proposed energy consumption load for the building construction project.

20. The non-transitory computer-readable medium of claim 18, wherein the energy code compliance form requires input of specific building component parameters, wherein the building design data comprises the specific building component parameters.
